(19) United States
(12) Patent Application Publication
(10) Pub. No.: US 2011/0037864 A1
(43) Pub. Date: Feb. 17, 2011

(54) Method and apparatus for live capture image

(75) Inventor: Jianhua Cao, Wainut, CA (US)

Correspondence Address: DAVID AND RAYMOND PATENT FIRM, 108 N. YNEZ AVE., SUITE 128, MONTEREY PARK, CA, 91754, US

(73) Assignee: Microseven Systems, LLC

(21) Appl. No.: 12/583,299

(22) Filed: Aug. 17, 2009

(51) Int. Cl. H04N 5/232

(52) U.S. Cl. 348/211.3; 348/E05.042

(57) ABSTRACT

A live image system for transferring live images via Internet includes one or more live image providers adapted for frequently capturing live image information with a predetermined capture interval, and a platform communicatively linking with the live image providers through Internet. The live image information, which is a still image file and a web based viewable format, is continuously transferred to the platform. Therefore when the live image information is kept refreshing at the platform by overwriting the previous live image information with the latest live image information, the platform provides a real time video like image at a predetermined frame rate for web browsers to watch without any proprietary software.

### BACKGROUND OF THE PRESENT INVENTION

1. Field of Invention

The present invention relates to a method and apparatus for image capture, and more particularly to a live image capture device which output is directly accessible by Internet users without the installation of proprietary software.

2. Description of Related Arts

Live image capture devices, commonly known as cameras, are used to record images. These images can then be perused in situations with a different time and place than where the image was taken. Because of these benefits and the advances in technology that have made cameras ubiquitous and available to most of the general public, cameras are widely used in modern society.

An example of the prevalence of cameras is the wide usage of cameras for security by both public and private institutions. In a scenario where an area needs to be continuously be monitored, cameras are often more suited for the job than humans, since images are recorded onto a hard medium and are viewable by others as long as the medium is maintained.

However, a camera by itself will most likely have just one function—capturing the image. One or more controllers must be employed to collect the data that is produced by the camera. In complex systems involving a multitude of cameras, the amount of resources required to maintain such a system increases significantly, and thus places limits on the efficiency of the system based on the available resources of the system's operator.

In such a system, high costs are accrued through the installation of the system itself. In a typical operation involving the installation of the system, the controller needs to be installed and secured. Then, the cameras themselves need to be installed in their respective positions, and a path of data transfer must be established between the cameras and the controller. Then, the interface of the system needs to be modified and adjusted to suit the operator's specifications, and so forth. This system cannot be very easily modified, and thus is limited in terms of flexibility.

The application of such systems is also limited by the medium upon which data is exchanged between the cameras and the controllers. Many existing camera-controller systems utilize wired networks in order to transfer data between the two. A well-known example of this is CCTV, where a signal from a camera is not openly transmitted, but broadcast to authorized controllers within the system. More modem systems employ Ethernet networks, such as the Internet, to transfer data.

Using the Internet protocol is highly advantageous, since most electronic devices today can in some way interact with this method of data transfer. However, the rate of data transfer in current systems is bottlenecked by the physical layer of the network infrastructure provided by the network service provider. An example of this is the fact that the current most popular network carriers, DSL and Internet cable, are only capable of uploading 1.5 Mb/s at maximum, which is hardly enough to transfer a high quality, high resolution video stream without delay.

A conventional way of solving this problem has been the act of video compression. This method has been widely used, but is not without its drawbacks. First, in order to compress video images transmitted by a camera, developers must create algorithm and codes for compression. This results in the creation of a plethora of compression codes, most incompatible with each other, in the market today.

Even when compression codes are relatively similar, minor differences in compression code from different providers can result in incompatibility. Consumers wishing to view electronic media must often face the daunting task of finding the correct decoding codec to match the code that the media was compressed with.

Another issue is currently used live video format is not editable. It is difficult to edit the display when the image is displayed lively.

Regarding the issues relating to current methods of image capture and transfer, there appears to be a need for the direct capture and transfer of images through a network.

### SUMMARY OF THE PRESENT INVENTION

The present invention involves a method and apparatus for the live capture of images and the direct transfer of the aforementioned electronically through an Internet network.

The present invention integrates a control circuit apparatus onto the motherboard of an image capture device. The onboard control circuit apparatus receives data from the image capture device, and converts the data into a standard format. The control circuit apparatus also acts as built-in a web server, providing a network interface to connect with the Internet, and continuously updates itself with new data transmitted from the image capture device. Users can then use the Internet to directly access the data from the image capture device by accessing the web server provided by the control circuit apparatus.

The present invention presents a method to transfer image information. When the image capture device records an image, the control circuit apparatus transfers the image data onto its own web server directly. Thus, this eliminates the need for an intermediate network between the camera itself and the controller. The control circuit apparatus will also contain an interface for modification of data transmittance, adjustable to the operator's specifications.

In order to avoid format incompatibility, the web server only transfers still image files in standard formats (such as JPEG, PNG, GIF, et cetera), and thus frees both the server- and client-side operators from the process of compression. Movement, or video, is simulated by the transfer of multiple still image files over a short interval of time.

The main object of the present invention is to provide a method and apparatus for an image capture device that is accessible in real-time.

Another object of the present invention is to provide a method and apparatus for live capture image which is easy to be connected with a network.

Another object of the present invention is to provide a method and apparatus for live capture image which doesn't does not require a separate controller.

Another object of the present invention is to provide a method and apparatus for live capture image which is easy to install.

Another object of the present invention is to provide a method and apparatus for live capture image which reduces the required resources to install the method and apparatus itself.

Another object of the present invention is to provide a method and apparatus for live capture image which is convenient to operator.

Another object of the present invention is to provide a method and apparatus for live capture image which is remote controllable.

Another object of the present invention is to provide a method and apparatus for live capture image which supports simultaneous viewing of multiple channels.

Another object of the present invention is to provide a method and apparatus for live capture image which provides high quality live images.

Another object of the present invention is to provide a method and apparatus for live capture image which image is editable.

Another object of the present invention is to provide a method and apparatus for live capture image which reduces the amount of required storage media to hold output data.

To accomplish the above objects, the present invention provides an apparatus for live capture image accessible though a network, comprising:

a housing;

an image capture device for capturing image information;

a control circuit electrically connected with the image capture device and communicatively connected with the network for converting the image information captured by the image capture device into predetermined image data and transferring the image data through the network, wherein the image capture device and the control circuit are received by the housing.

The present invention also provides a method for capture live image, comprising steps of:

(a) frequently capturing live image information with a predetermined capture interval by one or more live image providers;

(b) converting the live image information to a still image file in a web based viewable format;

(c) continuously transferring the converted still image files to a platform via Internet; and

(d) obtaining the converted still image files at the platform to form a real time video like image at a predetermined frame rate by continuously overwriting the previous live image information with the latest live image information, so as to allow web browsers to watch the real time video like image without any proprietary software.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a live capture image apparatus according to a preferred embodiment of the present invention.

FIG. 2 is a sectional view of a live image provider according to the above preferred embodiment of the present invention.

FIG. 3 is a schematic view of the live capture image system of the present invention.

FIG. 4 is a flow chart of the method for transferring live images according to the above preferred embodiment of the present invention.

### DETAILED DESCRIPTION OF THE PREFERRED EMBODIMENT

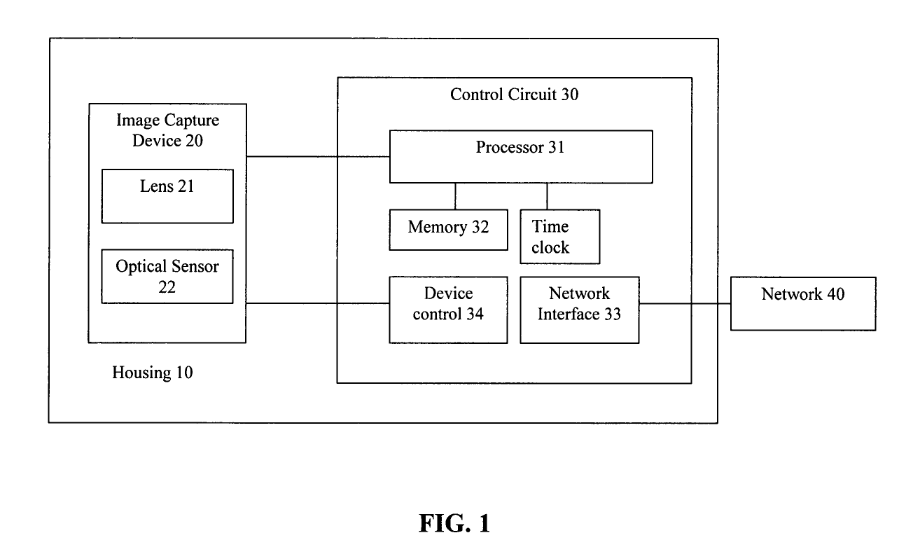

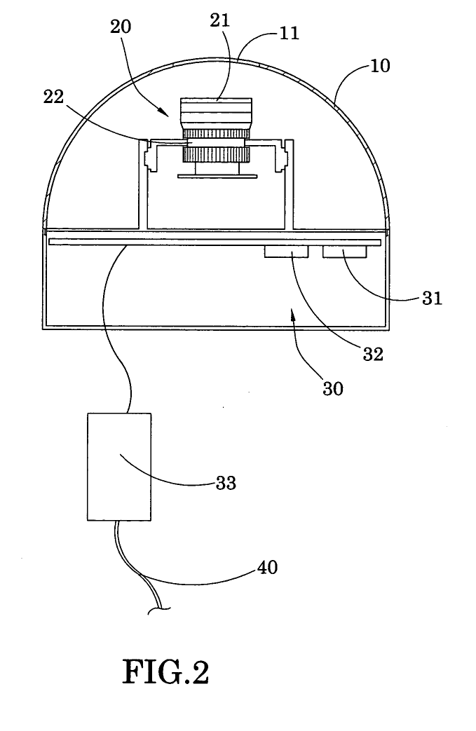

The present invention provides an apparatus for live capture image which is able to communicate with internet directly. Referring to FIGS. 1 and 2 of the drawings, a preferred embodiment of the present invention is illustrated, wherein an apparatus for providing live image, which is a live image provider, comprises a housing 10, an image capture device 20, and a control circuit 30.

The housing 10 is adapted for securely mounting at a predetermined location to securely receive the image capture device 20 and the control circuit 30. Referring to FIG. 2, the housing 10 thoroughly covers the image capture device 20 and the control circuit 30 to provide protection. Therefore, the sensitive components such as the image capture device 20 and the control circuit 30 are able to work normally in a large range of environment. The housing 10 also comprises a window 11 made of transparent material in front of the lens 21 of the image capture device 20, so light can transfer through the window 11 to reach the lens.

The image capture device 20 is adapted to capture image information and converts the captured image information into electronic signals. Preferably, an image capture device 20 comprises a lens 21 to capture light waves from a predetermined area, and an optical sensor 22 to convert the light waves into electronic signals. The electric signals can be transferred and processed later to reproduce the image by display devices, such as a computer monitor.

The image can be captured in different manners for different purposes. The image capture device 20 may take snapshot, which means capturing only one slide of image in a predetermined period of time. The image capture device 20 may take video, which means capturing a serial of slides of image in a short period of time, or in other words, taking snapshots continuously and frequently with short snapshot interval. Depending on the requirement, the image capture device 20 is able to provide different numbers of slides of image with different intervals.

Many techniques are appreciated to be applied in the image capture device 20 by whom skilled in the art. The embodiment of the present invention preferably utilizes but not limited to CCTV (Closed Circuit Television). In an alternative embodiment of the present invention, the apparatus for live capture image comprises more then one image capture devices to provide multiple channels of images. Therefore the user can accept multiple images simultaneously or alternatively.

The control circuit 30 comprises a processor 31, a memory 32, and a network interface 33. The control circuit 30 is electrically connected with the image capture device 20 to receive the electronic signals produced by the image capture device 20. The signals are converted into predetermined format, which is a web based viewable format, by the processor 31. The file format includes image file such as JPEG, and video file such as MP4, FLV, and MPEG. These files are stored in the memory 32. In a preferred embodiment, the image capture device 20 takes snapshots continuously and frequently with predetermined snapshot interval and resolution. The control circuit 30 converts the information of the snapshot into JPEG image files continuously and frequently and stores the image file in the memory 32. It is worth mentioning, the memory 32 is always refreshed by the latest image file, which means only the latest image file is saved in the memory 32, and the previous image file is overwritten. In this manner, only a small size of memory is need which raves the cost.

The control circuit 30 is also communicatively connected with a network 40, preferably the internet. Therefore the control circuit 30 is able to transfer image data via the network, and receive information, such as control information for the user via the network. In a preferred embodiment of the present invention, the network interface 33 is connected with internet via TCP/IP protocol.

The control circuit comprises a device control 34 operatively linked to the image capture device 20 for selectively adjusting the capture interval and resolution of the image capture device through the network 40.

The control circuit 30 also provides a web server function. When the network interface 33 is communicatively connected with the internet, the control circuit 30 runs a program which accepts HTTP requests from clients such as web browsers, and provides HTTP serving responses along with data contents which is the image and video data.

In a preferred embodiment, the web server provided by the control circuit 30 acquires an IP address from the internet provider. Then the web server maps the path component of a URL (Uniform Resource Locator) to this IP address. When the client's web browser requests to visit this URL, the web server will then read the memory 32 of the control circuit 30 where the image data is stored, and send the data to the web browser. In this way the client's web browser is able to download the image data to display. It is worth mentioning, the image file is saved at the root direction of the HTTP web server.

In the preferred embodiment of the present invention, when the client's web browser is linked with the web server provided by the control circuit 30 via Internet, the web server then transfers the existing image file from the memory 32 to the web browser. Since the image file already exists, which is static content, the transferring is much faster than transfer dynamic content such as a video file. Also, the web server transfers the image file continuously and frequently without further request from the web browser, it also improves the transferring speed. Because the image file stored in the memory 32 is always refreshed continuously and frequently, the web browser will continuously and frequently receive the most updated image and display these file continuously with the video effect. Therefore, live image is able to be accessed by a web browser from internet.

Because every apparatus for live capture image of the present invention is working independently, each web server of the apparatus obtains an IP address and is able to be connected with internet individually. Therefore, a plurality of apparatus for live capture image of the present invention can be networked together to provide multiple channels images.

The web server of the control circuit 30 is also able to receive commands from the client's web browser for controlling. In the preferred embodiment, the control comprises using an integer to select channel, using a Boolean to enable/disable the image capture device 20, and using a float to set the snapshot interval.

In an alternative embodiment, the control circuit 30 is connected with more than one image capture devices 20 to provide multiple channels of images. The channels can be selected by the user via network. The housing 10 comprises a plurality of units to receive the image capture devices 20 and the control circuit 30 individually.

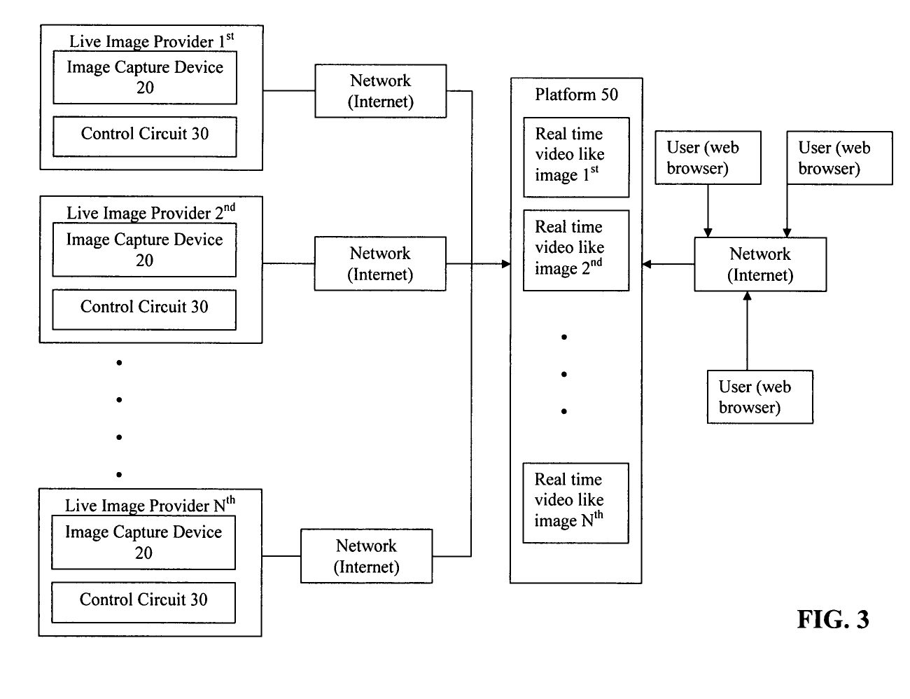

The present invention also provides a web based system to broadcast multiple channels of images. Referring to FIG. 3, the system comprises a platform 50 to communicatively link with one or more live image providers through Internet which is one of the networks as mentioned above. The platform 50 collects live images from the live image providers via Internet, and presents these live images to observers via Internet. The live image provider captures live image, convert the image information into real time videos in predetermined format, and transfer the image data to the platform 50 via Internet. In a preferred embodiment of the present invention, the platform 50 is a web based platform that the web browsers can access the platform 50 through Internet.

In a preferred embodiment of the system, the image capture device 20 of the live image provider takes snapshots frequently with a predetermined interval. The control circuit 30 of the live image converts the snapshots into image file, and uploads the image file constantly to the platform 50 via the internet. The image data is preferably in the format of still image file, such as JPEG file, PNG (Portable Network Graphic) file, GIF file, etc. These formats are standard formats which are supported by most web browsers, therefore the web client doesn't need to install any extra decoding program to view these images.

The snapshot interval of the image capture device 20 of the live image providers can be set by the user. The quality or resolution of each image file is also adjustable in responsive to the speed of Internet. In this way the user can control the data streaming. For example, when the transferring rate of the internet is high, and/or not many live image providers are uploading image files, the resolution of the image file may be higher for a better description of features. Also, the snapshot interval or the uploading interval could be shorter to provide smoother active effect of the live image. On the other hand, when more live image providers are connected with the platform 50 and the data transferring via the internet is heavier, a lower resolution, as well as a longer interval (lower frame rate) could be employed by the live image providers.

The live image provider may comprise more than one image capture device 20 to provide multiple channels of live images. These channels can be enabled or disabled by the user. The images of these channels can be transferred together or individually.

The memory 32 of the live image provider is used to store the image file. In a preferred embodiment, only the latest image file is saved, and the previous image file will be replaced by the most updated one. This will save a lot memory space. In an alternative embodiment, all image files are saved in the platform 50. The live image provider always uploads the latest image file to the platform 50 for updating.

The platform 50 is first communicatively connected with the live image provider through the internet. Then the platform 50 receives the uploaded image files from the live image provider. The platform 50 is able to connect with one or more than one live image providers. Because the connection is through internet, the live image providers can be distributed in any location with the access of internet. The connection is also controllable. Only authorized live image providers are allowed to be connected with the platform 50, which is also called registration of the live image providers. The platform 50 is also adapted to enable/disable particular live image providers and channels of the live image providers. The control also includes setting configures of each channels and live image provider such as snapshot interval and resolution, and security management.

Then the platform 50 presents the image file to show the live images provided by the live image providers, preferably in a web page. In the web page, the platform 50 display the most updated images received from each live image provider continuously. Since the images files are uploaded frequently and constantly with a relatively small interval, the displayed images are frequently refreshed which provides a real video image on the web page. When the user browses this web page, the user can watch those videos provided by those live image providers which are connected with the platform 50.

Accordingly, the frame rate of the real time video like image is adjustable by the platform 50 and is selectively controlled in responsive to the capture interval of each of the live image providers. In particularly, the frame rate of the real time video like image is selectively adjusted in responsive to a refreshing time interval of the converted still image file at the platform 50 to obtain the latest converted still image files. For example, when the refreshing time interval of the converted still image file at the platform 50 is set at 3 seconds, the frame rate of the real time video like image is selectively adjusted at 1 frame per 3 seconds. It is worth mentioning that the capture interval of the live image provider can be set at any desired time interval. For example, when the frame rate of the real time video like image is set at 1 frame per 3 seconds while the capture interval of the live image provider is set at 1 frame per second, two still image frames, i.e. the second and third still image frames, from the live image provider will be useless and will not be shown on the platform 50. Preferably, the frame rate of the real time video like image is set as the capture interval of the live image provider for optimum performance. Since the frame rate of the real time video like image is relatively low, such as 1 frame per second, in comparison with the frame rate of the video, such as 30 frames per second, the platform 50 can enhance the smoothness of the real time video like image in a real time manner. In addition, since the capacity of the still image is relative small, the still image can be instantly updated to the platform 50 to minimize the time delay of transferring.

The platform 50 also controls the access of the web page. Users or web clients need to be identified to access selected web pages which display live images from selected live image providers. The authorized user is able to interact with the platform 50 and the live image providers for setting. The user can select/unselect channels and live image providers, set the resolution and snapshot interval.

The system of the present invention is using still image file to transfer the image data. First, still image file has common and standard format. The platform 50 doesn't need to do the encoding which will take a lot of system resource. Therefore the processing speed is much faster then dealing with video format such as MJPG, MP4, H.264, etc. The cost of manufacturing the system is also reduced. Also, the web client doesn't need to install particular decoding program to display the live image. The standard still image file can be displayed by regular web browsers, and not extra system resource is needed. As a result, the processing speed is much faster in the system of the present invention, and there is no compatibility problem for the web clients. Second, since the size of the still image file is small compare with a video file, both the live image provider and the platform 50 can afford to save these file for record. This is very useful for many applications. Third, the system is highly controllable. The performance of the system is flexible to fulfill the requirement of any application. Because the capability of the Internet on physical layer is limited and uncontrollable by the user, the system of the present invention provides flexibility on the application layer.

Because of all the advantages, the system of the present invention is powerful and flexible in web based applications, especially when a large number of image channels are involved. For example, if the snapshot interval is 3 second, the size of each still image file is 70 K (kilo byte), then more than 100 different live images as the real time video images can be displayed together simultaneously. At the same time, the web browser doesn't need to install any extra program, the image resolution is acceptable without compression and losing frame.

It is worth mentioning that the live image provider is preferred to be the apparatus for providing live image as it is mentioned above. However, the live image provider can be CCTV or a mobile phone having a built-in camera such that the CCTV or a mobile phone can capture the still image and upload to the platform 50 to form the real time video like image thereon. In addition, the web browser is able to access the platform 50 to watch the real time video like image by using mobile phone, PDA, computer or other electronic devices which is able to communicatively link to the platform 50 through “WiFi”, Internet, or other communication network.

It is worth mentioning, using still image files also enable the platform 50 to edit and modify the live images to provide an add-on information for the live image files. Generally, for live videos, it is difficult to edit of modify the image on real time. But for still image files, for example PNG file, it is convenient to modify the image when display. Accordingly, the add-on information can be the comment or description of the image that adds onto the live image files. This provides the web server a great flexibility such as adding useful information on the live images.

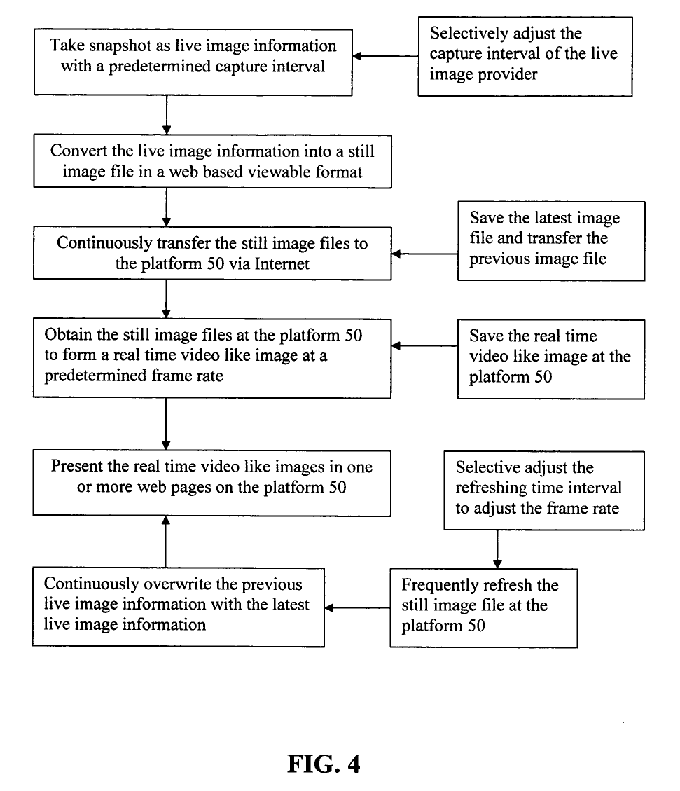

Referring to FIG. 4, the present invention provides a method for transferring live images via internet comprising the following steps.

(1) Frequently capture live image information with a predetermined capture interval by one or more live image providers.

(2) Convert the live image information to a still image file in a web based viewable format.

(3) Continuously transfer the converted still image files to a platform via Internet.

(4) Obtain the converted still image files at the platform to form a real time video like image at a predetermined frame rate by continuously overwriting the previous live image information with the latest live image information, so as to allow web browsers to watch the real time video like image without any proprietary software.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An apparatus for providing live image via a network, comprising:
a housing adapted for mounting at a predetermined location;
an image capture device supported within said housing for frequently capturing live image information with a predetermined capture interval; and
a control circuit received in said housing to electrically connect with said image capture device for communicatively connecting with said network, wherein said control circuit is arranged for converting said image information captured by said image capture device into a still image file in predetermined format and continuously transferring said converted image file to said network to provide a real time video like image in said network.

2. The apparatus, as recited in claim 1, wherein said control circuit comprises a memory to store said latest converted image file when said latest converted image file overwrites said previous converted image file which is transferred to said network.

3. The apparatus, as recited in claim 1, wherein said control circuit comprises a network interface adapted for communicating linking with said network through Internet, such that said control circuit forms a web server for continuously transferring said converted image file to said network through Internet.

4. The apparatus, as recited in claim 2, wherein said control circuit comprises a network interface adapted for communicating linking with said network through Internet, such that said control circuit forms a web server for continuously transferring said converted image file to said network through Internet.

5. The apparatus, as recited in claim 1, wherein said control circuit comprises a device control operatively linked to said image capture device for selectively adjusting said capture interval and resolution of said image capture device through said network.

6. The apparatus, as recited in claim 2, wherein said control circuit comprises a device control operatively linked to said image capture device for selectively adjusting said capture interval and resolution of said image capture device through said network.

7. The apparatus, as recited in claim 4, wherein said control circuit comprises a device control operatively linked to said image capture device for selectively adjusting said capture interval and resolution of said image capture device through said network.

8. A live image system for transferring live images via Internet, comprising:
one or more live image providers adapted for frequently capturing live image information with a predetermined capture interval, wherein said live image information is a still image file and a web based viewable format; and
a platform communicatively linking with said live image providers through Internet, wherein said live image information from each of said live image providers is continuously transferred to said platform in such a manner that when said live image information is kept refreshing at said platform by overwriting said previous live image information with said latest live image information, said platform provides a real time video like image at a predetermined frame rate for web browsers to watch without any proprietary software.

9. The system, as recited in claim 8, wherein each of said live image providers comprises a housing adapted for mounting at a predetermined location, an image capture device supported within said housing for frequently capturing said live image information with said predetermined capture interval, and a control circuit received in said housing to electrically connect with said image capture device for communicatively connecting with said platform, wherein said control circuit is arranged for converting said image information captured by said image capture device into said still image file in predetermined format and continuously transferring said converted image file to said platform to provide said real time video like image in said platform.

10. The system, as recited in claim 9, wherein said control circuit comprises a network interface communicating linking with said platform through Internet, such that said control circuit forms a web server for continuously transferring said converted image file to said platform through Internet.

11. The system, as recited in claim 8, wherein said frame rate is adjustable by said platform and is selectively controlled in responsive to said capture interval of each of said live image providers.

12. The system, as recited in claim 10, wherein said frame rate is adjustable by said platform and is selectively controlled in responsive to said capture interval of each of said live image providers.

13. The system, as recited in claim 10, wherein said control circuit comprises a device control operatively linked to said image capture device for selectively adjusting said capture interval and resolution of said image capture device through said platform in responsive to the speed of Internet, so as to enable multiplicity of said real time video like images from said live image providers concurrently providing at said platform.

14. The system, as recited in claim 12, wherein said control circuit comprises a device control operatively linked to said image capture device for selectively adjusting said capture interval and resolution of said image capture device through said platform in responsive to the speed of Internet, so as to enable multiplicity of said real time video like images from said live image providers concurrently providing at said platform.

15. The system, as recited in claim 14, wherein said still image file format is selected from a group consisting of JPEG, PNG, and GIF.

16. The system, as recited in claim 14, wherein said live image files are stored in said platform.

17. The system, as recited in claim 14, wherein said live image files are editable by said platform to provide an add-on information for said live image files.

18. A method for transferring live images via Internet, comprising steps of:
(a) frequently capturing live image information with a predetermined capture interval by one or more live image providers;
(b) converting said live image information to a still image file in a web based viewable format;
(c) continuously transferring said converted still image files to a platform via Internet; and
(d) obtaining said converted still image files at said platform to form a real time video like image at a predetermined frame rate by continuously overwriting said previous live image information with said latest live image information, so as to allow web browsers to watch said real time video like image without any proprietary software.

19. The method as recited in claim 18 wherein, in the step (d), said real time video like image is formed by frequently refreshing said converted still image file at said platform.

20. The method, as recited in claim 19, wherein the step (d) further comprises a step of selectively adjusting said frame rate of said real time video like image in responsive to a refreshing time interval of said converted still image file at said platform to obtain said latest converted still image files.

21. The method, as recited in claim 18, further comprising a step of concurrently providing multiplicity of said real time video like images from said live image providers.

22. The method, as recited in claim 20, further comprising a step of concurrently providing multiplicity of said real time video like images from said live image providers.

23. The method, as recited in claim 18, further comprising a step of storing said converted still image files in said platform from said live image providers.

24. The method, as recited in claim 22, further comprising a step of storing said converted still image files in said platform from said live image providers.
